(19) United States
(12) Patent Application Publication
(10) Pub. No.: US 2008/0157599 A1
(43) Pub. Date: Jul. 3, 2008

(54) Battery substitute to power and alarm small electronic devices on a display

(75) Inventors: Richard Ryczek, Butler, NJ (US); Alan Rabinowitz, Freehold, NJ (US)

Correspondence Address: EPSTEIN DRANGEL BAZERMAN & JAMES, LLP, 60 EAST 42ND STREET, SUITE 820, NEW YORK, NY, 10165, US

(73) Assignee: Vira Manufacturing, Inc.

(21) Appl. No.: 11/649,662

(22) Filed: Jan. 3, 2007

(51) Int. Cl. H02J 9/00; G08B 21/00

(52) U.S. Cl. 307/66; 340/687

(57) ABSTRACT

An apparatus to enable convenient connection to an external power source and alarming means for a battery powered hand-held electronic device on a display when the device lacks means for such a connection is provided. The apparatus fits in the space provided for conventional disposable batteries and comprises an insulating housing, preferably cylindrical in shape with metallic caps that function as positive and negative terminals at the ends and a printed circuit having reverse polarity protection means within the housing connecting the terminals, and an electrical lead connected to an electrical connector that protrudes through an opening in the housing and connects to the external power source and alarming means which feeds the required current and puts the device into an alarm circuit. The device further typically comprises a small metallic cylinder that loosely fits within a cavity in the exterior of the negative terminal and makes contact with the negative battery contact. Used in conjunction with the contemplated external power source and alarming means an alarm is sounded if the current fed to the device is disrupted. If the apparatus is removed from the device, the small cylinder is dislodged breaking the circuit and causing alarm signals. For devices requiring two or more batteries the device further comprises a similarly shaped unit having an electrical connection between its terminals that fills the space occupied by the additional batteries and establishes electrical connection with the device.

### BACKGROUND OF THE INVENTION

1. Field of the Invention

The present invention relates to an apparatus to supply power to a small electronic device on a display that is battery powered and has no provision for plug in power supply and to simultaneously provide an alarm signal in the event an attempt is made to pilfer said device.

2. Description of Prior Art Including Information Disclosed Under 37 CFR 1.97 AND 1.98

The display and demonstration of consumer electronic devices is an essential part of the sales process in today's marketplace. An apparatus that provides for the secure display and demonstration of small battery powered hand held electronic devices such as cell phones is disclosed in U.S. Pat. No. 6,659,382 issued to Ryczek on Dec. 9, 2003. U.S. Pat. No. 6,659,382 discloses a device that securely holds a battery powered device such as a cell phone and secures it to a tether that is part of a display apparatus.

The small devices such as cell phones that are contemplated in the aforesaid reference are generally powered by rechargeable batteries and provide a port for connection to recharging means. Means to recharge the batteries of such devices while they are on display for examination and trial by potential customers can conveniently make use of such ports to recharge device batteries without altering the device. Other small electronic devices such as MP3 players and the like often are not designed for use with rechargeable batteries and do not have a battery recharger port. Such devices that are designed to be powered by disposable batteries present a problem when on display as they require frequent battery changes due to heavy use or to avoid this they must be physically modified, for example, by soldering leads to the battery contacts to enable connection to an external DC power source which must supply the correct power. Either of these alternatives is inconvenient and time consuming. Physical modification of the device is especially inconvenient and time consuming as new models and devices are constantly introduced that would require such modification for display.

Yet another problem arising from the use of disposable batteries in small electronic devices placed on public display for demonstration is the ease of providing an alarm to prevent pilferage. With devices such as cell phones that are connected to an external power supply to recharge their batteries the external electrical connection can be used as part of an alarm system which is activated when the electrical connection is broken, thereby preventing pilferage from the display. With small electronic devices using disposable batteries this approach to alarming the device is not possible without installing a connection to an external power supply.

For the aforementioned reasons there is a need for a means that can supply power from an external power source that can be conveniently substituted for disposable batteries when devices designed to use only such batteries or that lack a connection for an external power source are displayed for examination and trial by potential customers.

There is a still further need for such a means to fit into the battery compartment of the battery powered device.

There is yet a further need for such a means to be reusable, but cheap enough to be disposable for the sake of efficiency.

There is a still further need for such a means to conveniently connect into an external alarm circuit to provide an alarm to prevent pilferage of the device.

### BRIEF SUMMARY OF THE INVENTION

It is an objective of the present invention to provide an apparatus to conveniently supply power from an external power source to small electronic devices designed to use only disposable batteries or that lack a connection for an external power source that are displayed for examination and trial by potential customers.

It is a further objective of the present invention to provide an apparatus that can be conveniently substituted for disposable batteries in such small electronic devices.

It is a still further objective of the present invention to provide an apparatus that can be conveniently connected to an external power supply that can supply the exact power required by a battery powered device.

It is also an objective of the present invention to provide an apparatus to supply power from an external source to a small battery operated device on a display that fits into the battery compartment of the battery powered device.

Another objective of the present invention is to provide an apparatus to supply power from an external source that can easily accommodate to the power requirements of any small hand held device using disposable batteries.

Yet another objective of the present invention is to provide an apparatus that can be easily and conveniently used with battery powered devices on display that are normally powered by more than one battery.

Yet a further objective of the present invention is to provide an apparatus that also conveniently provides connection to an external alarm circuit to prevent pilferage of such small battery operated electronic devices from a display.

Yet a further objective of the present invention is to provide an apparatus that provides means to facilitate breaking a circuit to an external alarm, thereby causing an alarm, if the apparatus is removed from the device.

According to the present invention for achieving the objects, there is provided an apparatus for

According to the present invention for achieving the objects, there is provided an apparatus to enable convenient connection to an external power source and alarming means for a battery powered hand-held electronic device on a display, the device lacking means for the connection integral to the device, the device having a battery compartment comprising a pair of battery contacts with each pair consisting of a positive contact and a negative contact, the apparatus comprising: electrically insulating housing means having open first and second ends, and an opening intermediate between the ends, and negative terminal means on the first end and positive terminal means on the second end, and circuitry means within the housing means connected to the terminal means, the circuitry means further comprising reverse polarity protection means, and an electrical lead from the circuitry protruding through the intermediate opening in the housing connected to electrical connection means, and bridging means to form an electrically conductive bridge between a contact and a one of the terminal means, wherein the apparatus fits within the battery compartment, with a one of the terminal means in operative electrical contact with a one of the battery contacts and with the bridging means interposed between and making operative electrical contact with the other of the terminal means and the other of the battery contacts, so that when the connection means is connected to the external power source and alarming means, a connection is formed wherein DC current of correct polarity as required by the device is provided to power the device, and the alarm means is activated to transmit an alarm signal to an external alarm if the connection is broken or severed or the apparatus is removed from the device causing the bridging means to be dislodged, thereby breaking electrical contact of the apparatus with the device.

In accordance with another aspect of the invention the bridging means comprises a shaped metallic object having two ends and the other of the terminal means further comprises a cavity to receive an end of the object. The shape of the metallic object is selected from disk, cylindrical and spherical shapes and combinations thereof. The metallic object is comprised of copper. In yet another aspect of the invention the metallic object is a copper cylinder.

In a further aspect of the apparatus of the invention the bridging means is interposed between the negative battery contact and the negative terminal means wherein the negative terminal means further comprises a cavity to receive the bridging means.

In accordance with another aspect of the invention the housing means is a hollow cylinder and the first and second ends are ends of the cylinder. In yet another aspect the hollow cylinder is comprised of clear polymeric material. In a further aspect the intermediate opening is a slit extending from the first end to the second end.

In another aspect of the invention the terminal means are terminal caps comprised of copper attached to the ends of the cylinder.

In accordance with another aspect of the invention the circuitry means is a flexible printed circuit connected to the positive and negative terminal means. In yet another aspect of the invention the electrical lead is a flexible printed circuit integral with the flexible circuit connected to the positive and negative terminal means.

In accordance with another aspect of the invention the battery compartment of the device further comprises a second set of battery contacts comprising a positive and a negative contact and the apparatus further comprises means to conduct the DC current, with the DC current conducting means forming an electrical connection between the second set of battery contacts. The conducting means comprises an insulating housing having two ends, with a conductive cap mounted on each end, and an electrical connection extending within the housing and electrically connecting the conductive caps.

In accordance with another aspect of the invention, there is provided a second embodiment of the apparatus to enable convenient connection to an external power source and alarming means for a battery powered hand-held electronic device on a display, that lacks means for such a connection that is integral to the device, when the device has a battery compartment comprising a pair of battery contacts with each pair consisting of a positive contact and a negative contact, the apparatus comprises: electrically insulating housing means having open first and second ends, and an opening intermediate between the ends, and an electrically conductive negative terminal on the first end and an electrically conductive positive terminal on the second end, and circuitry means within the housing means connected to the positive and negative terminals, the circuitry means further comprising reverse polarity protection means, and an electrical lead from the circuitry protruding through the intermediate opening in the housing and connected to an electrical connector, and a shaped metallic object having two ends to form an electrically conductive bridge between a terminal and contact, and with the negative terminal further comprising a cavity to receive an end of the metallic object, and wherein the apparatus fits within the battery compartment, with the positive terminal in operative electrical contact with the positive battery contact and with the shaped metallic object interposed between the negative battery contact and the negative terminal of the apparatus which receives an end of the metallic object within the cavity, wherein the metallic object makes operative electrical contact with the contact and the terminal, so that when the connector is connected to the external power source and alarming means, a connection is formed wherein DC current of correct polarity as required by the device is provided to power the device, and the alarm means is activated to transmit an alarm signal to an external alarm if the connection is broken or severed or the apparatus is removed from the device causing the shaped metallic object to be dislodged thereby breaking electrical contact between the apparatus with the device.

In accordance with another aspect of the second embodiment of the apparatus of the invention the metallic object is selected from metallic objects that are disk shaped, cylindrically shaped, spherically shaped or objects having shapes that are combinations thereof. In yet another aspect the metallic object is comprised of copper. In a further aspect the metallic object is cylindrical.

In accordance with yet another aspect of the second embodiment of the apparatus of the invention the housing means is a hollow cylinder comprised of polymeric material and the first and second ends are ends of the cylinder. In another aspect of the second embodiment the polymeric material is clear. In a further aspect of the second embodiment the intermediate opening is a slit extending from the first end to the second end.

In accordance with a further aspect of the second embodiment of the apparatus of the invention the terminals are comprised of copper and are inserted into the ends of the cylinder.

In accordance with a yet further aspect of the second embodiment of the apparatus of the invention the circuitry means is a flexible printed circuit connected to the positive and negative terminals. The electrical lead is a flexible printed circuit integral with the flexible circuit connected to the positive and negative terminals.

In accordance with a still yet further aspect of the second embodiment of the invention, when the battery compartment of the device further comprises a second set of battery contacts comprising a positive and a negative contact, the apparatus further comprises DC current conducting means forming an electrical connection between the second set of battery contacts. The conducting means comprises an insulating housing having a first end and a second end, and a conductive cap mounted on each end, and an electrical connection extending within the housing and electrically connecting the conductive caps.

In accordance with another aspect of the invention, a third embodiment of the apparatus to enable convenient connection to an external power source and alarming means for a battery powered hand-held electronic device on a display, wherein the device lacks means, integral to the device, for the connection and the device has a battery compartment comprising a pair of battery contacts with each pair consisting of a positive contact and a negative contact, the apparatus comprises: a hollow cylindrically shaped electrically insulating housing having a first and a second end, comprised of polymeric material, and having an opening intermediate between the ends, and a metallic cap mounted on the first end forming a negative terminal and a metallic cap mounted on the second end forming a positive terminal, and a printed circuit strip within the housing connected to the metallic caps, the circuitry further comprising reverse polarity protection means, and an electrical lead from the circuitry protruding through the intermediate opening in the housing and connected to an electrical connector, a shaped metallic object having two ends to form a bridge between the negative terminal and a battery contact, wherein the negative terminal further comprises a cavity to receive an end of the object, and wherein the apparatus fits within the battery compartment, with the positive terminal in operative electrical contact with the positive battery contact and with the shaped metallic object interposed between and forming a bridge between the negative battery contact and the negative terminal which receives an end of the metallic object within the cavity, wherein the metallic object makes operative electrical contact with the contact and the terminal, so that when the connector is connected to the external power source and alarming means, a connection is formed wherein DC current of correct polarity as required by the device is provided to power the device, and the alarm means is activated to transmit an alarm signal to an external alarm if the connection is broken or severed or the apparatus is removed from the device causing the shaped metallic object to be dislodged thereby breaking electrical contact of the apparatus with the device.

In accordance with another aspect of the third embodiment the metallic object is selected from metallic objects that are disk shaped, cylindrically shaped, spherically shaped or objects having shapes that are combinations thereof. In yet another aspect the metallic object is comprised of copper. In a further aspect the metallic object is cylindrical.

In yet another aspect of the third embodiment the polymeric material is clear. In a still further aspect of the third embodiment the intermediate opening is a slit extending from the first end to the second end of the cylindrical housing.

In accordance with a further aspect of the third embodiment of the apparatus of the invention the terminals are comprised of copper and are inserted into the ends of the cylinder.

In accordance with a yet further aspect of the third embodiment of the apparatus of the invention the circuitry means is a flexible printed circuit connected to the positive and negative terminals. The electrical lead is a flexible printed circuit integral with the flexible circuit connected to the positive and negative terminals.

In accordance with a still yet further aspect of the third embodiment of the invention, when the battery compartment of the device further comprises a second set of battery contacts comprising a positive and a negative contact, the apparatus further comprises DC current conducting means forming an electrical connection between the second set of battery contacts. The conducting means comprises a cylindrical insulating housing having a first end and a second end, and a conductive cap mounted on each end, and an electrical connection extending within the housing and electrically connecting the conductive caps. In accordance with yet another aspect of the third embodiment of the invention wherein battery contacts of the device are disposed at a distance to receive two batteries and a gap exists between the positive terminal of the apparatus and the positive battery contact, the apparatus of the present invention further comprises means to conduct the DC current through the gap, the means in electrical contact with the positive terminal and the positive battery contact so that when the shaped metallic object is interposed between and makes electrical contact with the negative battery contact DC current can flow through the apparatus. In a further aspect of the third embodiment the conducting means comprises a cylindrical insulating housing having a first end and a second end, and a conductive cap mounted on each end, and an electrical connection extending within the housing and electrically connecting the conductive caps.

In yet another aspect of the third embodiment of the apparatus of the invention the conducting means further comprises a metallic bridging object having a first and a second end, and a cavity in the exterior of one of the conductive caps to receive an end of the metallic object, wherein the conductive means when placed between the second set of battery contacts with a conductive cap in operative electrical contact with one of the second set of battery contacts and with the first end of the shaped metallic object in contact with the other of the second set of battery contacts and the second end received within the conductive cap cavity, the conducting means makes operative electrical contact with the second set of contacts.

### BRIEF DESCRIPTION OF THE SEVERAL VIEWS OF DRAWINGS

To these and to such other objects that may hereinafter appear, the present invention relates to Apparatus To Provide Power From An External Source And Alarming For A Battery Operated Device on Display as described in detail in the following specification and recited in the annexed claims, taken together with the accompanying drawings, in which like numerals refer to like parts and in which:

FIG. 1 is a side elevation-view looking through the outer wall of the device into the battery compartment of a small electronic device having a battery compartment containing an embodiment of the apparatus showing its components and the disposition of the apparatus relative to existing battery contacts;

FIG. 1A is an enlarged view showing a cavity in the end of a conductive cap, typically the negative conductive cap of the apparatus;

FIG. 1B is a three dimensional depiction of an embodiment of the apparatus showing an electrical lead protruding from the housing of the apparatus and a conductive cap insert separated from a conductive cap;

FIG. 1C is a three dimensional depiction of the end of the apparatus in FIG. 1B showing the cavity in the conductive end cap that receives the cap insert and the conductive cap insert;

FIG. 2A depicts a bottom view of an open battery compartment in a small battery powered electronic device ordinarily powered by two batteries in series in a linear head to tail arrangement wherein one battery is replaced by an embodiment of the apparatus and the other battery is replaced by an embodiment of a shunt unit; and

FIG. 2B depicts a bottom view of an open battery compartment in a in a small battery powered electronic device ordinarily powered by two batteries in series in a side by side arrangement wherein one battery is replaced by an embodiment of the apparatus and the other is replaced by an embodiment of shunt unit.

### DETAILED DESCRIPTION OF THE INVENTION

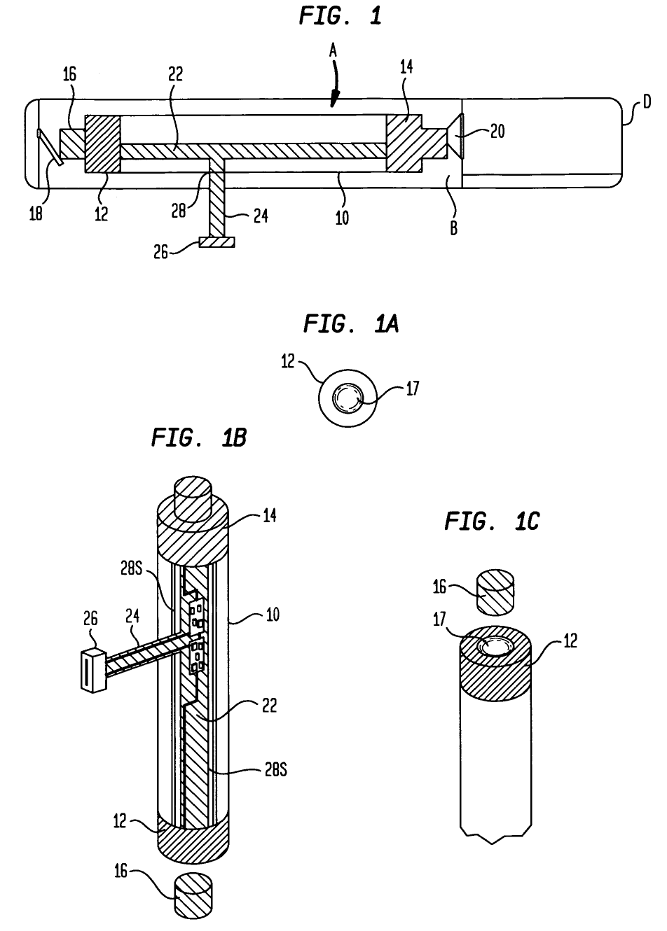

FIG. 1 depicts an embodiment of a battery power supply substitute apparatus A of the present invention inside the battery compartment B of an electronic device D. As seen in FIG. 1 an exemplified embodiment of the apparatus of the present invention comprises housing 10 having a first end and a second end, conductive cap 12 that fits on the first end of housing 10 is electrically negative and conductive cap 14 that fits on the second end of housing 10 is electrically positive, conductive cap insert 16 that loosely fits within well or depression 18 (FIG. 1A) situated in the end of negative conductive cap 12, and makes electrical contact with conductive cap 12, and contained within housing 10, circuit strip 22 electrically connected at its ends to conductive cap 12 and conductive cap 14, wherein strip 22 further comprises circuitry means for reverse polarity protection, and circuit strip lead 24 electrically connected to circuit strip 22 and to electrical connector 26, with circuit strip lead 24 protruding through an opening 28 (FIG. 1) or 28s (FIG. 1C) in the side of housing 10.

As shown in FIG. 1 when apparatus A is in use inside battery compartment B of device D, conductive cap insert 16 makes electrical contact with the existing internal negative battery contact 18 in battery compartment B and conductive cap 14 makes electrical contact with the existing internal positive battery contact 20 in battery compartment B. Battery contacts 18 and 20 are generally conductive springs found in small electronic devices designed to make electrical contact with a battery. Although only one such set of battery contacts is shown in FIG. 1, two or more sets of such contacts, generally electrically connected in series are often used in the small electronic devices to which the instant invention is directed.

Housing 10 is hollow and generally cylindrical in shape although other elongated shapes such as elongated boxes that are able to fit into the battery compartment of a small electronic device D can be used. Generally housing 10, which electrically separates electrically conductive cap 12 and electrically conductive cap 14 is made from an electrically insulating material, such as acrylics, polyolefins, polyesters and other polymeric materials, glass, ceramics and the like that can be formed into containers, preferably hollow cylinders. To avoid confusion with normal batteries housing 10 is preferably made from a clear rigid plastic material. Cap 12 and cap 14 and conductive cap insert 16 are made of conductive material, such as one of the metallic conductors commonly used in the art, for example copper, zinc, nickel, aluminum, ferrous metals and alloys thereof, preferably copper due to its high electrical conductivity. Apparatus A generally has the shape and approximate dimensions of any of the commercially available disposable batteries such as AAA or AA or other generally commercially available batteries used to power devices such as MP3 players, personal digital assistants, digital cameras, radios, certain types of headphones, radio-headphone combinations and the like. The dimensions of apparatus A including conductive cap insert 16 are generally such that the apparatus replaces an AAA, AA or other battery intended to fit between terminals 18 and 20 in battery compartment B of device D. Generally at least one of the battery contacts 18 and 20 of device D will be a spring which provides a snug conductive fit of an AAA or AA or other commercially available disposable battery and therefore will provide a snug fit for the corresponding embodiment of apparatus A (FIG. 1).

Printed circuit strip 22 connected to conductive cap 12 and conductive cap 14 and having circuit strip lead 24 is a printed circuit board (PC board) that may be either flexible or rigid but is preferably a flexible or flex circuit as these are more economical and convenient to work with and facilitate construction of apparatus A. PC board 22, which is preferably a flex circuit, further comprises circuitry means as known in the art to provide polarity reversal protection to device D. In the event the polarity of input DC current supplied to connector 26 (FIG. 1) from an external power source (not shown), is reversed relative to the assigned polarities of negative terminal 18 and positive terminal 20 of device D, the reverse polarity protection circuitry means on PC board 22 shuts device D down thereby protecting it from damage.

Circuit strip lead 24 preferably forms an integral part of circuit strip 22 and together with circuit strip 22 forms a “T” shaped printed circuit which may be manufactured by means known in the art as a single continuous circuit which is preferably a flex circuit. In one embodiment of the present invention circuit strip lead 24 emerges from housing 10 through an opening 28 (FIG. 1) which may be a slit 28s (FIG. 1B) and extends beyond battery compartment B of device D so that connector 26 (FIGS. 1, 1B) may be connected to an external source of DC power and an alarm system (not shown). Flex circuits are preferred for circuit strip lead 24 as flex circuits may generally be made thin enough to allow replacement of the battery compartment cover (not shown), which is generally a snap fit or screw down fit, while also allowing circuit strip lead 24 to emerge from battery compartment B of device D. In the event the battery cover cannot be neatly replaced on battery compartment B with lead 24 coming through, the battery cover may be taped in place or secured by other means known in the art. In practice, as device D while on public display is attached to a security tether by means of a bracket or adhesive security pad on the rear of the device where the battery compartment cover is generally situated, the rear of the device is not readily seen by a potential customer examining the device.

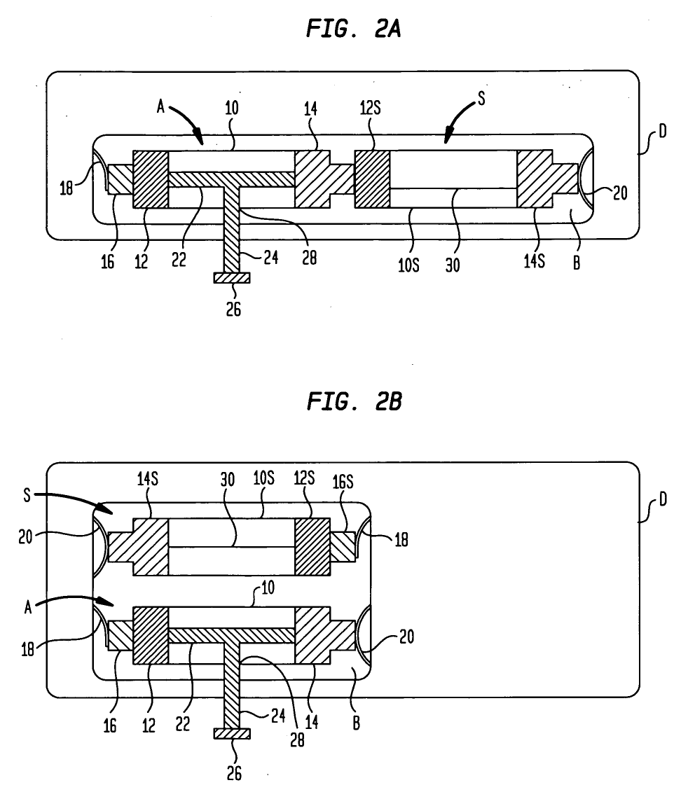

Conductive caps 12 and 14 are formed by machining or other processes known in the art and may be of any convenient shape, preferably generally cylindrical or stacked cylindrical (see FIGS. 1-2B) to resemble the batteries for which they substitute, and are of a dimension to permit a tight fit when inserted into the open first and second ends of housing 10. Housing 10 which is preferably a cylindrical tube may for example be prepared with a slit running from the first end of housing 10 to the second end of the housing (FIG. 1B) so that in cross-section housing 10 has a “C” shape. PC strip 22 is electrically connected to caps 12 and 14, preferably the interior of caps 12 and 14 by means known in the art. Conductive cap 12 has a cavity, well or depression 17 machined or formed by other means into its exterior end to loosely receive conductive cap insert 16. An embodiment of apparatus A may be assembled by inserting circuit strip 22, preferably a flex circuit, having a sufficient length through opening 28, preferably a slit 28s (FIG. 1B) running the length of housing 10 to facilitate assembly, so that circuit strip lead 24, connected to connector 26, protrudes through opening 28 or 28s, and electrically connecting the negative end of strip 22 to the interior of conductive cap 12 and the positive end of strip 22 to the interior of conductive cap 14 and pressing caps 12 and 14 into the first and second ends of housing 10. To ensure a permanent fit of caps 12 and 14 adhesives, tapes and the like may be used to seal caps 12 and 14 to housing 10. Circuit strip lead 24, which is preferably a printed flexible circuit that is integral to flexible circuit 22, must have sufficient length to extend beyond battery compartment B of device D. Conductive cap insert 16 is inserted into well 17 where it fits loosely.

In practice, apparatus A, of the present invention, including conductive cap 16 is inserted into the battery compartment B of a small electronic device D on a display (FIG. 1) and connector 26 is connected to an outside source of DC power (not shown) that delivers the voltage and current equivalent to that delivered by the disposable batteries normally required for operation of device D and also provides alarm circuitry that sends an alarm signal to an alarm if current flow to device D is interrupted. An apparatus for the secure display of small electronic devices that provides the appropriate DC power and an alarming system over two wires such as that disclosed in provisional patent application 60/775,935 of Rabinowitz, et al filed Feb. 23, 2006 is contemplated as the source of outside power and the alarm system for use with the battery substitute of the present invention. In practice, device D containing apparatus A of the present invention is attached to a security tether by means of a bracket or adhesive security pad that forms part of an apparatus such as the aforesaid apparatus for the secure display of small electronic devices. Connector 26 of apparatus A of the present invention is attached to a two wire connector of the aforesaid apparatus for the secure display of small electronic devices which then sends the required power through apparatus A to power device D and includes device D in an alarm circuit. Device D is then supplied with the required power for operation and there is no need to change batteries in device D while it is on display. Should any attempt be made to pilfer device D from the display, any interruption of power caused by disconnecting connector 26 or by removing apparatus A from device D will produce an alarm signal that will result in an audible alarm. If an attempt is made to remove apparatus A from battery compartment B, conductive cap insert 16 will drop out of well 17, thereby preventing reestablishment of electrical connection and insuring the sending of alarm signals resulting in an audible alarm.

FIG. 2A depicts a bottom view of an open battery compartment in a device D ordinarily powered by two batteries in series in a linear head to tail arrangement wherein one battery is replaced by the apparatus A of the present invention and the other is replaced by a shunt unit S (also referred to as conductive means) that fills the space ordinarily occupied by one of the batteries and makes electrical contact between positive contact 20 and positive conductive cap 14 of apparatus A thereby forming a closed circuit to allow current supplied through apparatus A to flow to device D. FIG. 2B depicts a bottom view of an open battery compartment in a device D ordinarily powered by two batteries in series in a side by side arrangement wherein one battery is replaced by the apparatus A of the present invention and the other is replaced by a shunt unit S that fills the space ordinarily occupied by one of the batteries, wherein the shunt makes electrical contact between positive contact 20 and negative contact 18 on one side of battery compartment B thereby forming a closed circuit to allow current supplied through apparatus A to flow to device D.

Shunt device S has substantially the same dimensions and shape as the corresponding apparatus A and may be formed in the same manner and from the same materials as apparatus A with the exception that circuit strip 22 and circuit strip lead 24 are replaced by electrical connection 30 which creates a continuous electrical connection from negative conductive cap 12 to positive conductive cap 14. Electrical connection 30 may be made with any conductive means including electrical wire, a rigid or flexible circuit strip or a conductive metallic strip such as a copper strip. Well or depression 17 is optionally present in conductive cap 12 as is conductive cap insert 16. When an embodiment of shunt device S having well or depression 17 with loosely fitting conductive cap insert 16 is used in conjunction with apparatus A and power and alarming is provided by an apparatus such as that disclosed in provisional patent application 60/775,935 of Rabinowitz, et al filed Feb. 23, 2006, there is greater assurance that an alarm signal will be sent and continue to be sent should an attempt be made to remove either apparatus A or shunt S from battery compartment B as in either case conductive cap insert 16 will drop out preventing reestablishment of the circuit. As will be evident to those skilled in the art either the apparatus A or shunt S may be used in any order in battery compartment B. In alternative embodiments of apparatus A the length of the apparatus may be made equivalent to the length of two batteries that are mounted head to tail as in FIG. 2A thereby obviating the need for shunt S or Apparatus A may also be made as a single unit incorporating a shunt in order to fit the situation depicted in FIG. 2B.

Accordingly, when used in conjunction with the aforementioned apparatus for secure display of small electronic devices, current is always delivered to device D via apparatus A from an outside source thereby eliminating the need to replace the batteries of a device D on display, that does not have a built in means to connect to an outside current source. In this manner apparatus A thereby insures that a potential customer will always examine a fully powered product. In the event that battery substitute apparatus A is removed from device D or apparatus A is unplugged a power circuit is broken causing an alarm signal to be sent to external alarm means causing an audible or other alarm to be set off.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims:

1. Apparatus to enable convenient connection to an external power source and alarming means for a battery powered hand-held electronic device on a display, said device lacking means for said connection integral to said device, said device having a battery compartment comprising a pair of battery contacts with each pair consisting of a positive contact and a negative contact, said apparatus comprising:
electrically insulating housing means having open first and second ends, and an opening intermediate between said ends, and
negative terminal means on said first end and positive terminal means on said second end, and
circuitry means within said housing means connected to said terminal means, said circuitry means further comprising reverse polarity protection means, and an electrical lead from said circuitry protruding through said intermediate opening in said housing connected to electrical connection means, and
bridging means to form an electrically conductive bridge between a contact and a one of said terminal means,
wherein said apparatus fits within said battery compartment, with a one of said terminal means in operative electrical contact with a one of said battery contacts and with said bridging means interposed between and making operative electrical contact with the other of said terminal means and the other of said battery contacts, so that when said connection means is connected to said external power source and alarming means, a connection is formed wherein DC current of correct polarity as required by said device is provided to power said device, and said alarm means is activated to transmit an alarm signal to an external alarm if said connection is broken or severed or said apparatus is removed from said device causing said bridging means to be dislodged, thereby breaking electrical contact of said apparatus with said device.

2. The apparatus of claim 1 wherein said bridging means comprises a shaped metallic object having two ends and said terminal further comprises a cavity to receive an end of said object.

3. The apparatus of claim 2 wherein said shape of said metallic object is selected from disk, cylindrical and spherical shapes and combinations thereof.

4. The apparatus of claim 3 wherein said metallic object is comprised of copper.

5. The apparatus of claim 4 wherein said metallic object is cylindrical.

6. The apparatus of claim 1 wherein said bridging means is interposed between said negative battery contact and said negative terminal means wherein said negative terminal means further comprises a cavity to receive said bridging means.

7. The apparatus of claim 1 wherein said housing means is a hollow cylinder and said first and second ends are ends of said cylinder.

8. The apparatus of claim 7 wherein said hollow cylinder is comprised of clear polymeric material.

9. The apparatus of claim 7 wherein said intermediate opening is a slit extending from said first end to said second end.

10. The apparatus of claim 7 wherein said terminal means are terminal caps comprised of copper attached to said ends of said cylinder.

11. The apparatus of claim 1 wherein said circuitry means is a flexible printed circuit connected to said positive and negative terminal means.

12. The apparatus of claim 11 wherein said electrical lead is a flexible printed circuit integral with said flexible circuit connected to said positive and negative terminal means.

13. The apparatus of claim 1 wherein said battery compartment of said device further comprises a second set of battery contacts comprising a positive and a negative contact and said apparatus further comprises means to conduct said DC current, with said DC current conducting means forming an electrical connection between said second set of battery contacts.

14. The apparatus of claim 13 wherein said conducting means comprises an insulating housing having two ends with a conductive cap mounted on each end, and an electrical connection extending within said housing and electrically connecting said conductive caps.

15. Apparatus to enable convenient connection to an external power source and alarming means for a battery powered hand-held electronic device on a display, said device lacking means for said connection integral to said device, said device having a battery compartment comprising a pair of battery contacts with each pair consisting of a positive contact and a negative contact, said apparatus comprising:
electrically insulating housing means having open first and second ends, and an opening intermediate between said ends, and
an electrically conductive negative terminal on said first end and an electrically conductive positive terminal on said second end, and
circuitry means within said housing means connected to said positive and negative terminals, said circuitry means further comprising reverse polarity protection means, and an electrical lead from said circuitry protruding through said intermediate opening in said housing and connected to an electrical connector, and
a shaped metallic object having two ends to form an electrically conductive bridge between a terminal and contact, and with said negative terminal further comprising a cavity to receive an end of said metallic object, and
wherein said apparatus fits within said battery compartment, with said positive terminal in operative electrical contact with said positive battery contact and with said shaped metallic object interposed between said negative battery contact and said negative terminal of said apparatus which receives an end of said metallic object within said cavity, wherein said metallic object makes operative electrical contact with said contact and said terminal, so that when said connector is connected to said external power source and alarming means, a connection is formed wherein DC current of correct polarity as required by said device is provided to power said device, and said alarm means is activated to transmit an alarm signal to an external alarm if said connection is broken or severed or said apparatus is removed from said device causing said shaped metallic object to be dislodged thereby breaking electrical contact between said apparatus with said device.

16. The apparatus of claim 15 wherein said metallic object is selected from metallic objects that are disk shaped, cylindrically shaped, spherically shaped or objects having shapes that are combinations thereof.

17. The apparatus of claim 16 wherein said metallic object is comprised of copper.

18. The apparatus of claim 17 wherein said metallic object is cylindrical.

19. The apparatus of claim 15 wherein said housing means is a hollow cylinder comprised of polymeric material and said first and second ends are ends of said cylinder.

20. The apparatus of claim 19 wherein said polymeric material is clear.

21. The apparatus of claim 19 wherein said intermediate opening is a slit extending from said first end to said second end.

22. The apparatus of claim 19 wherein said terminals are comprised of copper and are inserted into said ends of said cylinder.

23. The apparatus of claim 15 wherein said circuitry means is a flexible printed circuit connected to said positive and negative terminals.

24. The apparatus of claim 23 wherein said electrical lead is a flexible printed circuit integral with said flexible circuit connected to said positive and negative terminals.

25. The apparatus of claim 15 wherein said battery compartment further comprises a second set of battery contacts comprising a positive and a negative contact and said apparatus further comprises DC current conducting means forming an electrical connection between said second set of battery contacts.

26. The apparatus of claim 25 wherein said conducting means comprises an insulating housing having a first end and a second end, and a conductive cap mounted on each end, and an electrical connection extending within said housing and electrically connecting said conductive caps.

27. Apparatus to enable convenient connection to an external power source and alarming means for a battery powered hand-held electronic device on a display, said device lacking means for said connection integral to said device, said device having a battery compartment comprising a pair of battery contacts with each pair consisting of a positive contact and a negative contact, said apparatus comprising:
a hollow cylindrically shaped electrically insulating housing comprised of polymeric material, having a first end and a second end, and having an opening intermediate between said ends, and
a metallic cap mounted on said first end forming a negative terminal and a metallic cap mounted on said second end forming a positive terminal, and
a printed circuit strip within said housing connected to said metallic caps, said circuitry further comprising reverse polarity protection means, and an electrical lead from said circuitry protruding through said intermediate opening and connected to an electrical connector, and
a shaped metallic object having two ends to form a bridge between said negative terminal and a battery contact, wherein said negative terminal further comprises a cavity to receive an end of said object, and
wherein said apparatus fits within said battery compartment, with said positive terminal in operative electrical contact with said positive battery contact and with said shaped metallic object interposed between and forming a bridge between said negative battery contact and said negative terminal which receives an end of said metallic object within said cavity, wherein said metallic object makes operative electrical contact with said contact and said terminal, so that when said connector is connected to said external power source and alarming means, a connection is formed wherein DC current of correct polarity as required by said device is provided to power said device, and said alarm means is activated to transmit an alarm signal to an external alarm if said connection is broken or severed or said apparatus is removed from said device causing said shaped metallic object to be dislodged thereby breaking electrical contact of said apparatus with said device.

28. The apparatus of claim 27 wherein said metallic object is selected from metallic objects that are disk shaped, cylindrically shaped, spherically shaped or objects having shapes that are combinations thereof.

29. The apparatus of claim 28 wherein said metallic object is comprised of copper.

30. The apparatus of claim 29 wherein said metallic object is cylindrical.

31. The apparatus of claim 27 wherein said polymeric material is clear.

32. The apparatus of claim 27 wherein said intermediate opening is a slit extending from said first end to said second end.

33. The apparatus of claim 27 wherein said terminals are comprised of copper and are inserted into said ends of said cylinder.

34. The apparatus of claim 27 wherein said circuitry means connected to said metallic caps is a flexible printed circuit.

35. The apparatus of claim 34 wherein said electrical lead is a flexible printed circuit integral with said flexible circuit connected to said metallic caps.

36. The apparatus of claim 27 wherein said battery compartment of said device further comprises a second set of battery contacts comprising a positive and a negative contact and said apparatus further comprises means to conduct said DC current between said second set of battery contacts.

37. The apparatus of claim 36 wherein said conducting means comprises a cylindrical insulating housing having a first end and a second end, and a conductive cap mounted on each end, and an electrical connection extending within said housing and electrically connecting said conductive caps, with said conductive caps in electrical contact with said second set of battery contacts.

38. The apparatus of claim 27 wherein said set of battery contacts of said device are disposed at a distance to receive two batteries and a gap exists between said positive terminal and said positive battery contact, and said apparatus further comprises means to conduct said DC current through said gap, said means in electrical contact with said positive terminal and said positive battery contact.

39. The apparatus of claim 38 wherein said conducting means comprises a cylindrical insulating housing having a first end and a second end, and a conductive cap mounted on each end, and an electrical connection extending within said housing and electrically connecting said conductive caps.

40. The apparatus of claim 37 wherein said conducting means further comprises a metallic bridging object having a first and a second end, and a cavity in the exterior of a one of said conductive caps to receive an end of said metallic object, wherein said conductive means when placed between said second set of battery contacts with a conductive cap in operative electrical contact with a one of said second set of battery contacts and with said first end of said shaped metallic object in contact with the other of said second set of battery contacts and said second end received within said conductive cap cavity, said conducting means makes operative electrical contact with said second set of contacts.
